(19) United States
(12) Patent Application Publication
(10) Pub. No.: US 2021/0175513 A1
(43) Pub. Date: Jun. 10, 2021

(54) LAMINATED ELECTROLYTIC FOIL

(71) Applicant: TOYO KOHAN CO., LTD., Tokyo (JP)

(72) Inventors: Shinichirou HORIE, Tokyo (JP); Etsuro TSUTSUMI, Kudamatsu-shi (JP); Toshifumi KOYANAGI, Kudamatsu-shi (JP); Koh YOSHIOKA, Kudamatsu-shi (JP)

(73) Assignee: Toyo Kohan Co., Ltd., Tokyo (JP)

(21) Appl. No.: 17/045,918

(22) PCT Filed: Feb. 18, 2019
(86) PCT No.: PCT/JP2019/005815

§ 371 Date: Oct. 7, 2020

(30) Foreign Application Priority Data
Apr. 13, 2018 (JP) 2018077939

(51) Int. Cl. H01M 4/66; B32B 15/01; B32B 15/20; C25D 1/04; C25D 7/06; C25D 5/12

(52) U.S. Cl. CPC H01M 4/667; B32B 15/01; B32B 15/20; H01M 4/661; C25D 7/0614; C25D 5/12; C25D 1/04

(57) ABSTRACT

[Problem] To provide a laminated electrolytic foil having strength sufficient to successfully suppress tearing or ripping during manufacture, the tearing or ripping being concerned accompanying with a trend toward thinner structures in battery current collectors, and improved in handling properties during the manufacture, and also a battery using the laminated electrolytic foil.

[Solution] A laminated electrolytic foil includes a first metal layer formed from Cu and a second metal layer formed from Ni or an Ni alloy, in which the first metal layer and the second metal layer are laminated together. The laminated electrolytic foil has an overall layer thickness, which is the thickness of the laminated electrolytic foil as a whole, of 3 to 15 μm and tensile strength of 700 MPa or higher.

### TECHNICAL FIELD

The present invention relates to a laminated metal foil useful as a battery current collector suited for a secondary battery or the like.

### BACKGROUND ART

Since the emergence of a dry battery in Japan for the first time in the world, portable and readily transportable batteries have played an important role in various industries led by the electrical equipment field. Downsizing of electronic equipment is remarkable especially in recent years, resulting in widespread use of portable electronic equipment such as mobile phones and portable information terminals. In such portable electronic equipment, rechargeable reusable secondary batteries are mounted as their power sources.

Secondary batteries are not only mounted in portable electronic equipment as described above, but, coupled with gasoline resource exhaustion problems, environmental problems, and the like, have also been gradually mounted in vehicles such as hybrid vehicles and electric vehicles. Among secondary batteries to be mounted in portable electronic equipment or automotive vehicles as described above, lithium-ion secondary batteries (hereinafter is also referred to as “LiBs”) are attracting interest as high-output, long-life, and high-performance batteries.

The above-described LiBs have been playing a main position in applications to portable equipment, but for vehicle-mount applications and as batteries for stationary storage, nickel-hydrogen secondary batteries are still adopted and studied for improvements from the viewpoint of safety and long-term reliability.

Especially in the field of automotive vehicles, there is a rapidly growing need for electric vehicles, and for full-scale spreading, developments are accelerated toward higher capacity and quick charge/discharge lithium-ion secondary batteries for vehicle-mount applications. In addition, there is also an active move toward higher-performance nickel-hydrogen secondary batteries for hybrid vehicles and the like.

Now, use of thinner current collectors is effective for providing batteries including lithium-ion secondary batteries and nickel-hydrogen batteries, with higher capacity. However, a reduction in the thickness of a current collector leads to lower strength, raising a problem that a concern arises regarding deformation, breakage, or the like of the current collector.

For this problem, PTL 1, for example, proposes a technique to apply electroplating, which uses a plating bath containing a nickel salt and an ammonium salt, to at least a surface of an electrolytic foil formed from a metal material having low capability of forming a lithium compound, thereby forming a hard nickel plating layer on the surface of the electrolytic foil.

Further, PTL 2, for example, discloses a technique to apply nickel plating, which leaves no much residual stress in copper, to a copper foil to be used as an anode current collector, thereby suppressing formation of a cupper sulfide and providing the anode current collector with excellent electrical conductivity.

### CITATION LIST

### Patent Literature

### [PTL 1]

JP 2005-197205A

### [PTL 2]

JP 2016-9526A

### SUMMARY

### Technical Problems

However, the techniques described in the above pieces of patent literate are considered to still have room for improvements in at least the following points although, as current collectors, some improvement is made in strength.

Described specifically, there is an ever-increasing demand for battery performance in recent years. If a current collector itself is reduced in thickness, the amount of an active material can be increased by that reduction. Accordingly, the current collector is desired to have strength sufficient to suppress tearing or ripping which occurs during manufacture as a result of the reduction in the thickness of the current collector.

Further, anode current collectors, for example, have been strongly desired to have high strength capable of conforming to the properties of a new active material replaceable for carbon, such as silicon.

In addition, smaller-thickness and higher-strength electrolytic foils are also desired for applications other than current collectors, for example, for applications such as heat dissipation materials and electromagnetic wave shielding materials.

Nonetheless, the above-described PTL1 and PTL2 disclose nothing more than a technical concept that forms a plurality of layers by using a nickel coating, and contain no disclosure about such strength as mentioned above, saying nothing of a specific structure for realizing high levels of handling properties during assembly of batteries.

The present invention has been made with a view to resolving such problems, and has as objects thereof the provision of a battery current collector having strength sufficient to successfully suppress tearing or ripping during manufacture, the tearing or ripping being concerned accompanying a trend toward thinner structures, and a battery including the battery current collector.

### Solution to Problems

(1) A laminated electrolytic foil of an embodiment includes a first metal layer formed from Cu and a second metal layer formed from Ni or an Ni alloy. The first metal layer and the second metal layer are laminated together. The laminated electrolytic foil has an overall layer thickness of 3 to 15 μm and tensile strength of 700 MPa or higher.

In (1) described above, (2) the laminated electrolytic foil preferably has a three-layer structure that the second metal layer, the first metal layer, and the second metal layer are laminated in this order.

As an alternative in (1) described above, (3) the laminated electrolytic foil preferably has a three-layer structure that the first metal layer, the second metal layer, and the first metal layer are laminated in this order.

In any one of (1) to (3) described above, (4) the second metal layer preferably has a thickness ratio of 0.45 or greater but 0.9 or smaller relative to the overall layer thickness as a sum of the first metal layer and the second metal layer.

In any one of (1) to (4) described above, (5) the second metal layer preferably has hardness of 3500 to 5500 N/mm².

In any one of (1) to (5) described above, (6) Ni in the second metal layer laminated on the first metal layer preferably has a crystal orientation index of 0.3 or greater in a (200) plane, and the crystal orientation index of the (200) plane/a crystal orientation index of a (220) plane preferably has a value of 0.1 to 5.0.

In any one of (1) to (5) described above, (7) the Ni alloy preferably contains Fe.

In any one of (1) to (7) described above, (8) the overall layer thickness is preferably 4 to 10 μm.

Further, a battery in the embodiment preferably includes the laminated electrolytic foil described in any one of (1) to (8) described above.

### Advantageous Effects of Invention

According to the present invention, it is possible to obtain a laminated electrolytic foil improved in strength such that foil ripping can be suppressed even when the laminated electrolytic foil is reduced in thickness. Further, sandwiching of a Cu layer between Ni layers can suppress corrosion of the Cu layer, so that the resulting laminated electrolytic foil can also be applied even to a battery which has satisfied a demand for higher voltage and the like.

### BRIEF DESCRIPTION OF DRAWINGS

FIG. 1 presents schematic diagrams depicting cross-sections of laminated electrolytic foils of an embodiment.

FIG. 2 is a flow diagram illustrating a manufacturing process for the laminated electrolytic foils of the embodiment.

FIG. 3 is a schematic diagram illustrating a specimen in a tensile strength test of a laminated electrolytic foil in the embodiment.

### DESCRIPTION OF EMBODIMENT

### First Embodiment

A description will hereinafter be made about an embodiment for carrying out the present invention.

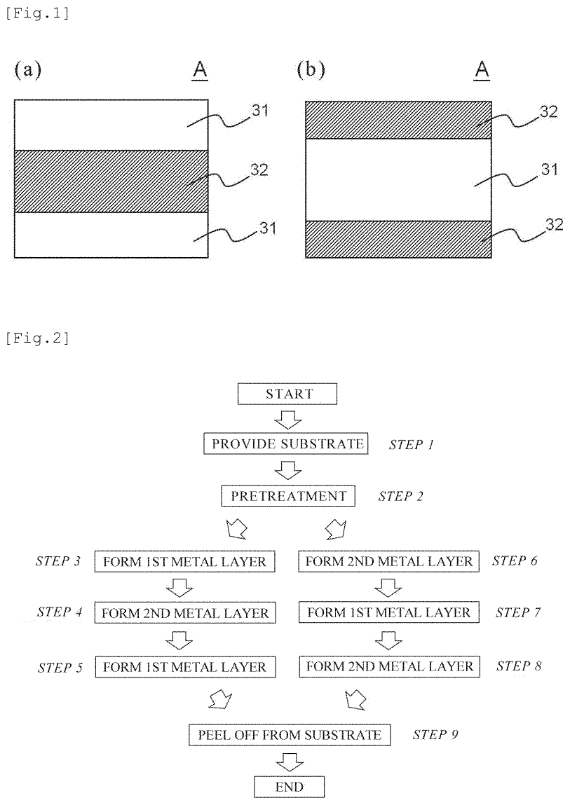

FIG. 1 presents diagrams schematically depicting laminated electrolytic foils according to the embodiment. It is to be noted that the laminated electrolytic foils of the embodiment can be applied not only as current collectors in battery anodes but also as current collectors in battery cathodes.

Each laminated electrolytic foil A of the embodiment has a form in which plural metal layers are laminated together as depicted in FIG. 1. Described specifically, the laminated electrolytic foil A is configured of two or one first metal layer 31 and one or two second metal layers 32 laminated together.

The laminated electrolytic foil A, as a whole, has a thickness (an overall layer thickness) of 3 to 15 μm, more preferably 4 to 10 μm. A thickness greater than 15 μm fundamentally does not conform to a design concept on the basis of a background with an aim to achieve a higher capacity through a reduction in thickness, and moreover, leads to a loss or reduction of a cost advantage over known rolled foils. A thickness smaller than 3 μm, on the other hand, not only makes it difficult to have strength sufficient to withstand effects associated with charging and discharging, but also leads to a higher possibility of causing rupturing, wrinkling, or the like during manufacture or the like of batteries.

In the embodiment, the first metal layer 31 is formed from Cu. The first metal layer 31 has a thickness with a limit not exceeding the above-described thickness of the laminated electrolytic foil A as a whole, for example, of 0.5 to 10 μm.

In the embodiment, the first metal layer 31 is formed by plating. Described specifically, the first metal layer 31 can be formed using a known copper sulfate plating bath. If this is the case, the first metal layer 31 can be a Cu plating layer with no brightener added (may also be referred to as a “matte Cu plating layer” for the sake of convenience), or a bright Cu plating layer with an additive such as a brightener (or a brightener for semi-brightness) added.

It is to be noted that the above-described “bright” or “matte” relies upon a visual evaluation of the appearance and is difficult to be distinguished in terms of precise numerical values. Moreover, the degree of brightness is also variable depending on other parameters such as a bath temperature to be described subsequently herein. The terms “bright” and “matte” to be used in the embodiment are thus basically defined when a focus is placed on the inclusion or non-inclusion of an additive (brightener).

The second metal layer 32 is laminated on the first metal layer 31. The second metal layer 32 is a layer that contains an Ni element. Described specifically, the second metal layer 32 is formed from Ni or an Ni alloy.

Examples of the Ni alloy include an Ni—Fe alloy, an Ni—Co alloy, an Ni—W alloy, an Ni—P alloy, dispersion Ni plating containing Si, carbon, or Al particles, and so on.

Of these, use of an Ni—Fe alloy as the Ni alloy is preferred to provide the laminated electrolytic foil with preferred strength.

If this is the case, the Ni—Fe alloy preferably has a Fe proportion of 5 to 80 wt %.

In particular, to improve the strength of the laminated electrolytic foil as a whole in this case, the Fe proportion is more preferably 5 to 70 wt %, with 10 to 60 wt % being still more preferred.

If importance is placed on the cost, on the other hand, the Fe proportion is preferably 50 to 80 wt %.

It is to be noted that the second metal layer 32 has a thickness with a limit not exceeding the above-described thickness of the laminated electrolytic foil A as a whole, and the thickness is preferably 1 to 10 μm, for example.

On the other hand, the ratio of the thickness of the second metal layer 32 (if there is a plurality of the second metal layers 32, their total thickness) to the thickness of the laminated electrolytic foil as a whole (the overall layer thickness as the sum of the first metal layer(s) and the second metal layer(s)) is preferably 0.45 or greater but 0.9 or smaller.

A thickness ratio of the second metal layer(s) 32 smaller than 0.45 is not preferred because the laminated electrolytic foil cannot be provided with preferred strength. It is to be noted that a more preferred thickness ratio is 0.5 or greater.

A thickness ratio of the second metal layer(s) 32 greater than 0.9, on the other hand, is not preferred either because the laminated electrolytic foil is, as a whole, lowered in electrical conductivity although the laminated electrolytic foil is improved in strength. From the viewpoint of electrical conductivity, the thickness ratio is preferably 0.85 or smaller, more preferably 0.8 or smaller.

In the embodiment, the second metal layer 32 is formed by plating similarly to the first metal layer 31, so that bright plating (including semi-bright) or matte plating can be applied.

It is to be noted that as will be described subsequently herein, upon manufacture of the laminated electrolytic foil A, the first metal layer 31, the second metal layer 32, and the additional first metal layer 31 are laminated in this order by plating on a substrate formed from a titanium plate, a stainless steel plate, or the like, and the plating layers are then peeled off in their entirety from the substrate to obtain the laminated electrolytic foil A (see FIG. 1(a)). As an alternative, the laminated electrolytic foil A may be obtained by laminating the second metal layer 32, the first metal layer 31, and the additional second metal layer 32 in this order by plating on a substrate and then peeling off the plating layers in their entirety from the substrate (see FIG. 1(b)).

In other words, the laminated electrolytic foil of the embodiment may have a three-layer structure with the second metal layer sandwiched between the adjacent two first metal layers as depicted in FIG. 1(a). As an alternative, the laminated electrolytic foil of the embodiment may have a three-layer structure with the first metal layer sandwiched between the adjacent two second metal layers as depicted in FIG. 1(b).

However, the above-described laminating orders are merely illustrative, and the laminated electrolytic foil of the embodiment should not be limited thereto. The laminated electrolytic foil of the embodiment may have, for example, a four-layer structure or a five-layer structure, and may also have a still greater number of layers. For example, the laminated electrolytic foil of the embodiment may have a four-layer structure with “a first metal layer 31, a second metal layer 32, another first metal layer 31, and another second metal layer 32” laminated in this order. As an alternative, the laminated electrolytic foil of the embodiment may have a five-layer structure with “a second metal layer 32, a first metal layer 31, another second metal layer 32, another first metal layer 31, and a further second metal layer 32” laminated in this order.

Further, it is not absolutely needed to position the first metal layer 31 or the second metal layer 32 as an outermost layer of the laminated electrolytic foil A. For example, a different metal layer (for example, a layer formed from a further metal) may additionally be arranged as an outer layer on the first metal layer 31 or the second metal layer 32.

### <Tensile Strength of Laminated Electrolytic Foil>

In the embodiment, the laminated electrolytic foil is characterized by tensile strength of 700 MPa or higher. If the tensile strength of the laminated electrolytic foil is lower than 700 MPa, ripping or rupturing of the foil may occur during the manufacture of a battery in the case where the thickness of the laminated electrolytic foil as a whole (the overall layer thickness) is as small as 15 μm or less. Such low tensile strength is therefore not preferred as handling properties are lowered. In the embodiment, tensile strength of 700 MPa or higher can be achieved even if the thickness of the laminated electrolytic foil as a whole (the overall layer thickness) is smaller than 6 μm. If the thickness of the laminated electrolytic foil as a whole (the overall layer thickness) is 6 μm or greater, preferred tensile strength of 800 MPa or higher can be obtained.

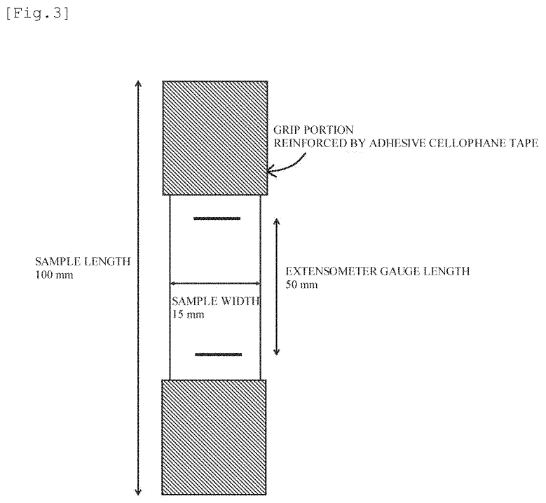

It is to be noted that in the embodiment, the tensile strength of the laminated electrolytic foil is expressed in terms of a value obtained by a testing method conducted following the “Metallic materials—Tensile testing method” described in JIS Z 2241. Each specimen was prepared by setting the width at 15 mm and the extensometer gauge length at 50 mm and reinforcing grip portions with an adhesive cellophane tape as illustrated in FIG. 3, and then a tensile test was conducted.

### <Crystal Orientation Index of Second Metal Layer Laminated on First Metal Layer>

In the laminated electrolytic foil of the embodiment, a preferred crystal orientation index differs depending on the kind of the second metal layer. A description will hereinafter be made in detail.

First, if the second metal layer laminated on the first metal layer is matte Ni or bright Ni, Ni preferably has a crystal orientation index of 0.3 or greater in a (200) plane, and the crystal orientation index of the (200) plane/a crystal orientation index of a (220) plane preferably has a value of 0.1 to 5.0.

The laminated electrolytic foil of the embodiment is specified as described above by focusing on the crystal orientation indexes of the (200) plane and (220) plane of Ni for reasons to be described below.

It is to be noted that no physical mechanism has yet been fully elucidated on the ratio of the crystal orientation indexes of Ni to be described below. For example, there is also a possibility that grain size diameter, residual stress, and the like, in addition to crystal orientation index, in combination may affect the properties of the laminated electrolytic foil. Nonetheless, as a result of a diligent study by the present inventors in view of such a possibility, suitable parameters were found and were specified as described above, leading to the present invention.

Described specifically, the main slip system of an Ni crystal (face-centered cubic lattice: FCC) is (111) plane, [1-10] direction. Now, a relation between the (200) plane and the [1-10] direction will be considered. No slip is crystallographically considered to occur in the [1-10] direction on the (200) plane, and therefore, Ni is presumed to become brittle if there is a high trend of orientation along the (200) plane. In other words, if the (200) plane has a preferred orientation, the laminated electrolytic foil is presumed to have a tendency of embrittlement although its strength becomes remarkably higher.

In view of a relation between the (220) plane and the [1-10] direction, on the other hand, a slip is crystallographically considered to occur in the [1-10] direction on the (220) plane, thereby possibly contributing to deformation. In other words, if the (220) plane has a preferred orientation, the laminated electrolytic foil is presumed to be high in strength and to have some toughness.

From the foregoing, it has been decided, with a focus placed on the (220) plane and the (200) plane, to specify the laminated electrolytic foil of the embodiment as described above.

It is to be noted that, if the value of the crystal orientation index of the (200) plane/the crystal orientation index of the (220) plane is smaller than 0.1, Ni cannot manifest sufficient hardness and that, if the value of the crystal orientation index of the (200) plane/the crystal orientation index of the (220) plane is greater than 5.0, on the other hand, the toughness is lowered and the crystal orientation is offset, both accompanying an increase in the strength of Ni. Further, due to the offset crystal orientation, pinholes (plating defect) tend to increase, and these pinholes may act as starting points of rupturing, resulting in a possibility that the laminated electrolytic foil of the embodiment is reduced in tensile strength. Therefore, such an excessively small or great value of the crystal orientation index of the (200) plane/the crystal orientation index of the (220) plane is not preferred.

Further, if the crystal orientation index of the (200) plane of Ni is smaller than 0.3, Ni may not be provided with sufficient strength, so that such a small crystal orientation index is not preferred.

If the second metal layer laminated on the first metal layer is matte Ni or bright Ni in the laminated electrolytic foil of the embodiment, it is more preferred that, in addition to the above-mentioned numerical value range of the crystal orientation index, the crystal orientation index of the (200) plane and the crystal orientation index of the (220) plane are both 3.7 or smaller. Still more preferably, the crystal orientation index of the (200) plane and the crystal orientation index of the (220) plane are both 3.3 or smaller.

For the foregoing finding, the following reasons can be given. Described specifically, if a high degree of preferred orientation such that the crystal orientation index of either the (200) plane or the (220) plane exceeds 3.7 is manifested, sufficient strength can be obtained by setting the thickness ratio at 0.8 or greater. If the crystal orientation index of either the (200) plane or the (220) plane is 3.7 or smaller, however, sufficient strength can be obtained at a thickness ratio of not only 0.8 or greater but also smaller than 0.8, and therefore such a small crystal orientation index of either the (200) plane or the (220) plane is preferred. No detailed reasons are known, but if a high degree of preferred orientation arises in one of such directions as described above, a relatively low stress at the time of plating is considered to be a cause of difficulty in increasing the strength.

It is to be noted that, especially if the second metal layer laminated on the first metal layer is matte Ni in the laminated electrolytic foil of the embodiment, the crystal orientation index of the (220) plane, in particular, is preferably 0.5 to 3.7, more preferably 0.7 to 3.3. Reasons for this finding are as described above.

Especially if the second metal layer laminated on the first metal layer is matte Ni, the value of the crystal orientation index of the (200) plane/the crystal orientation index of the (220) plane, in particular, is more preferably 0.1 to 5.0, still more preferably 0.3 to 3.0. Reasons for this finding are as described above.

Especially if the second metal layer laminated on the first metal layer is bright Ni in the laminated electrolytic foil of the embodiment, on the other hand, the crystal orientation index of the (111) plane is preferably 1.0 or greater.

For the foregoing finding, the following reasons can be given. Described specifically, in the case of bright Ni, starting points of rupturing are considered to be reduced owing to a suppression of the occurrence of pinholes by leveling action even if the (111) plane has a preferred orientation. Further, a marked improvement in strength is considered to be assured because bright Ni has a smaller grain size than matte Ni. Furthermore, crystals of Ni, which are oriented along the (111) plane, deposit in the form of a layer with respect to the thickness direction of the laminated electrolytic foil, so that the laminated electrolytic foil as a whole is increased in hardness and improved in tensile strength.

For the reasons as mentioned above, the crystal orientation index of the (111) plane preferably has the above-described numerical value especially if the second metal layer laminated on the first metal layer is bright Ni.

Especially if the second metal layer laminated on the first metal layer is bright Ni in the laminated electrolytic foil of the embodiment, the value of the crystal orientation index of the (200) plane/the crystal orientation index of the (220) plane is preferably 1.5 or greater. Reasons for this finding are the same as the above-mentioned reasons, that is, Ni is provided with preferred hardness.

Especially if the second metal layer laminated on the first metal layer is an Ni—Fe alloy in the laminated electrolytic foil of the embodiment, on the other hand, the crystal orientation index of the (111) plane is preferably 1.0 or greater. Further, the crystal orientation index of the (200) plane is preferably 1.0 or greater. As reasons for this finding, the hardness of the layer is increased owing to enhanced solid solution of Ni and Fe, so that the tensile strength of the laminated electrolytic foil as a whole is improved.

Now, a crystal orientation index in the embodiment is defined as will be described hereinafter. Described specifically, when analyzed by X-ray diffraction, nickel has an orientation mainly along four planes, that is, its (111) plane, (200) plane, (220) plane, and (311) plane, the peaks of which can be observed individually.

When Ni is analyzed by X-ray diffraction in the embodiment, peaks of Cu and Ni or Cu and Ni—Fe are concurrently detected in an X-ray diffraction graph of Ni as a measurement target. This is attributed to the fact that the measurement sample is Ni on the Cu substrate or the Ni—Fe alloy on the Cu substrate. Individual peak tops are clearly distinguishable from each other, and therefore the crystal orientation index of Ni alone can be calculated.

Now, as standard diffraction peak intensity values of the individual crystal planes of Ni, the values as described in the Joint Committee on Powder Diffraction Standards (JCPDS, PDF card number: 00-004-0850) can be used, and so do the diffraction angles (20).

It is to be noted that the crystal orientation index of the Ni—Fe alloy is defined likewise with the standard diffraction peaks of Ni.

In the embodiment, the crystal orientation index I_{co}(hkl) of an (hkl) plane was calculated based on the following formula.

$$Ico ( hk1 ) = \frac{\begin{matrix}[ I ( hkl ) / [ I ( 111 ) ) + I ( 200 ) \\ + I ( 220 ) + I ( 311 ) ] ]\end{matrix}}{\begin{matrix}[ Is ( hk1 ) / [ Is ( 111 ) + Is ( 200 ) \\ + Is ( 220 ) + Is ( 311 ) ] ]\end{matrix}} \qquad [ Math . 1 ]$$

Here, I(hkl) represents the diffraction peak intensity of each crystal plane (hkl) of the Ni layer or the Ni alloy layer as measured by X-ray diffraction.

Further, Iₛ(hkl) represents the standard diffraction peak intensity of the crystal plane (hkl) when standard Ni powder was used [the subscript “s” stands for Standard].

It is to be noted that each diffraction peak intensity in this application should not be an integrated value but a peak value.

From the values of I(hkl) and Iₛ(hkl) described above, the crystal orientation index I_{co}(hkl) of the laminated electrolytic foil is defined in accordance with the above-described formula (the subscript “co” stands for crystal orientation).

### <Hardness of Second Metal Layer>

In the embodiment, the hardness of Ni or the Ni alloy in the second metal layer is preferably 3500 to 5500 N/mm². This hardness can be measure by a hardness tester such as a known micro hardness tester to be described subsequently herein, for example. As an alternative, a Martens hardness measured following JIS Z 2255 or ISO 14577 can also be used as the hardness in the embodiment.

It is to be noted that, if the hardness of Ni or the Ni alloy in the second metal layer is lower than 3500 N/mm², no preferred strength can be obtained for the whole laminated electrolytic foil, and such low hardness is hence not preferred. If the hardness of Ni or the Ni alloy in the second metal layer is higher than 5500 N/mm², on the other hand, the toughness is extremely low in a thin foil of 15 μm or less, so that the thin foil may conversely be prone to rupture. Further, a laminated electrolytic foil having such excessively high hardness may involve difficulty in being formed by plating, and therefore such excessively high hardness is not preferred.

### <Surface Roughness of Laminated Electrolytic Foil>

More preferably, the laminated electrolytic foil of the embodiment may be provided with a surface roughness Ra (arithmetic mean roughness) of ≥0.1 μm at its outermost surface on which an active material is to be deposited. Described specifically, by controlling the surface roughness of the outermost layer of the laminated electrolytic foil as described above, the laminated electrolytic foil can be improved in the adhesion with the active material when formed into a current collector, resulting in a battery having improved performance. Still more preferably, the surface roughness Ra (arithmetic mean roughness) is ≤0.3 μm.

No particular limitation is imposed on a method for controlling the surface roughness Ra (arithmetic mean roughness) of the laminated electrolytic foil of the embodiment as described above. For example, the above-described surface roughness Ra (arithmetic mean roughness) can be obtained by going through a known post-plating or etching step after the manufacture of the laminated electrolytic foil.

### <Manufacturing Method of Laminated Electrolytic Foil (Current Collector)>

A description will next be made about a manufacturing method of the laminated electrolytic foil A (the current collector A) of the embodiment. As the manufacturing method of the laminated electrolytic foil A of the embodiment, it is preferred to manufacture it through steps such as those illustrated in FIG. 2, for example.

Described specifically, a substrate for the manufacture of a laminated electrolytic foil is first provided (step 1). For example, a known metal plate such as a titanium plate or a stainless steel plate is used as the substrate, although the substrate is not particularly limited to such a known metal plate.

The substrate may be subjected to a known pretreatment as needed (step 2). The known pretreatment can be conducted for the purpose of avoiding interfusion of foreign materials into the electrolytic foil or inhibition of the formation of a plating layer or for the purpose of facilitating peeling between the substrate and the electrolytic foil after the lamination of the electrolytic foil. Examples of the known pretreatment include polishing, wiping, rinsing with water, degreasing, pickling, and the like. These pretreatments may be sequentially conducted by a roll-to-roll method in the course that the substrate wound in a coil form is unrolled and transferred. It is to be noted that the step 2 is an optional step and may be omitted if not needed.

Next, a first metal layer is formed on the substrate (step 3). The first metal layer is formed by bright Cu plating or matte Cu plating.

Then, a second metal layer is formed on the first metal layer (step 4). The second metal layer is formed by Ni plating or Ni-alloy plating. Examples of the Ni-alloy plating can include Ni—Fe alloy plating and the like.

It is to be noted that this Ni plating or Ni-alloy plating may be bright plating, semi-bright plating, or matte plating.

Thereafter, another first metal layer is additionally formed on the second metal layer formed in step 4 (step 5).

It is to be noted that in the manufacturing method of the laminated electrolytic foil in the embodiment, the following steps of step 6 to step 8 may be followed in place of the above-described steps of step 3 to step 5. Described specifically, a second metal layer may first be formed on the substrate (step 6), a first metal layer may next be formed on the second metal layer formed in step 6 (step 7), and another second metal layer may be additionally formed on the first metal layer formed in step 7 (step 8).

It is to be noted that the layer to be formed in step 5 or step 8 described above can also be expressed as “a third metal layer.” Similarly, the layer to be formed in step 3 or step 6 can also be expressed as “a first metal layer,” and the layer to be formed in step 4 or step 7 can also be expressed as “a second metal layer.”

The layers formed in the above-described step 3 to step 5 or step 6 to step 8 may also be collectively called “the plating layers.”

Subsequently, the plating layers are peeled off from the substrate, so that the laminated electrolytic foil A of the embodiment can be obtained (step 9). As a peeling method, a known method can be applied, and no particular limitation is imposed thereon. In the step 9, a known chemical agent or the like may be used as needed to facilitate the peeling.

Before the peeling from the substrate or after the peeling, a roughening treatment, a rust-preventive treatment, or the like may be applied to the surface of the outermost layer of the laminated electrolytic foil A. As an alternative, a known treatment such as carbon coating may be applied to impart electrical conductivity.

Among these, conditions for the matte Cu plating are as will be described next.

### [Matte Cu Plating Conditions]

Bath composition: a known copper sulfate bath containing copper sulfate as a principal component (one example will be described below)
   Copper sulfate: 150 to 250 g/L
   Sulfuric acid: 30 to 60 g/L
   Hydrochloric acid (as 35%): 0.1 to 0.5 ml/L
Temperature: 25° C. to 70° C.
pH: 1 or lower
Agitation: air agitation or jet agitation
Current density: 1 to 30 A/dm²

It is to be noted that a bright Cu plating bath can be prepared if a brightener is added at 1 to 20 ml/L to the above-described matte Cu plating bath. As the brightener in the bright Cu plating, a known brightener is used, and no particular limitation is imposed thereon. Examples include organic sulfur compounds such as saccharin and sodium naphthalene sulfonate, aliphatic unsaturated alcohols such as polyoxyethylene addition products, unsaturated carboxylic acids, formaldehyde, coumarin, and the like.

As conditions for the matte Ni plating, it is possible to use a known Watts bath or sulfamate bath to be described next.

### [Matte Ni Plating (Watts Bath) Conditions]

Bath composition: a known Watts bath (one example will be described below)
   Nickel sulfate: 200 to 350 g/L
   Nickel chloride: 20 to 50 g/L
   Boric acid (or citric acid): 20 to 50 g/L
Temperature: 25° C. to 70° C. (preferably 30° C. to 40° C.)
pH: 3 to 5
Agitation: air agitation or jet agitation
Current density: 1 to 40 A/dm² (preferably 8 to 20 A/dm²)

It is to be noted that a preferred relation between the above-described bath temperature and current density is as will be described hereinafter.

First, if the bath temperature is 25° C. or higher but 45° C. or lower, the current density is preferably 5 to 20 A/dm². Here, if the current density exceeds 20 A/dm², a problem arises that a coating of Ni plating is not formed. If the current density is lower than 5 A/dm², on the other hand, another problem arises that the resulting layer of Ni is less likely to be provided with sufficient strength. This problem is considered to be attributable to the fact that the crystal orientations of the (200) plane and (220) plane tend to become low.

If the bath temperature is higher than 45° C. and 70° C. or lower, the current density is preferably 3 to 10 A/dm², more preferably 3 to 6 A/dm². If the current density is lower than 3 A/dm², the productivity is extremely lowered, so that such a low current density is not preferred. If the current density exceeds 10 A/dm², on the other hand, the resulting Ni layer may be less likely to be provided with sufficient strength.

Here, this difficulty in providing the Ni layer with sufficient strength is caused by different reasons depending on the combination of current density and a temperature, and is considered to be attributable to the setting of conditions under which the (200) plane and (220) plane are provided with an excessively low crystal orientation or crystal grains are prone to grow coarse during plating.

If the pH is lower than 3, the deposition efficiency of the plating decreases, so that such a low pH is not preferred. If the pH is higher than 5, on the other hand, sludge may be interfused in the resulting layer, so that such a high pH is not preferred either.

It is to be noted that the above-described matte Ni plating bath can be changed to a bright Ni plating bath if a brightener is added at 0.1 to 20 ml/L. As a brightener in bright Ni plating bath, a known brightener is used, and no particular limitation is imposed thereon. Examples include organic sulfur compounds such as saccharin and sodium naphthalene sulfonate, aliphatic unsaturated alcohols such as polyoxyethylene addition products, unsaturated carboxylic acids, formaldehyde, coumarin, and the like. Further, an anti-pitting agent may also be added in an appropriate amount to the matte Ni plating bath or the bath added with the brightener.

If changed to the bright Ni plating bath, a bath temperature of 30° C. to 60° C. and a current density of 5 to 40 A/dm² are particularly preferred as plating conditions. Reasons for this finding are the same as in the matte Ni plating bath described above.

### [Matte Ni Plating (Sulfamate Bath) Conditions]

Bath composition: a known nickel sulfamate plating bath (one example will be described below)
   Nickel sulfamate: 150 to 300 g/L
   Nickel chloride: 1 to 10 g/L
   Boric acid: 5 to 40 g/L
Temperature: 25° C. to 70° C.
pH: 3 to 5
Agitation: air agitation or jet agitation
Current density: 5 to 30 A/dm²

The above-described known brighter or the like may also be added to the plating bath to prepare a bright Ni plating or a semi-bright Ni plating. An anti-pitting agent may also be added in an appropriate amount.

It is to be noted that, if the second metal layer is formed in the above-described sulfamate bath, the ratio of the second metal layer to the thickness of the laminated electrolytic foil as a whole (the overall layer thickness) is preferably set at 0.8 or greater. If this ratio is smaller than 0.8, the laminated electrolytic foil as a whole may not be provided with preferred strength, so that such a small ratio is not preferred.

### [Ni—Fe Alloy Plating Conditions]

Bath composition:
   Nickel sulfate: 150 to 250 g/L
   Ferrous chloride: 5 to 100 g/L
   Nickel chloride: 20 to 50 g/L
   Boric acid: 20 to 50 g/L
   Sodium citrate (or trisodium citrate): 1 to 15 g/L
   Saccharin: 1 to 10 g/L
Temperature: 25° C. to 70° C.
pH: 2 to 4
Agitation: air agitation or jet agitation
Current density: 5 to 40 A/dm²

It is to be noted that concerning the above-described bath temperature, no layer may be deposited at a temperature lower than 25° C., and such a low temperature is not preferred accordingly. If higher than 70° C., on the other hand, no sufficient tensile strength can be assured for the resulting layer, so that such a high bath temperature is not preferred.

If the pH is lower than 2, the deposition efficiency of the plating decreases, so that such a low pH is not preferred. If the pH is higher than 4, on the other hand, sludge may be interfused in the resulting layer, so that such a high pH is not preferred either.

Concerning current density, if lower than 5 A/dm², the productivity may be lowered, and if higher than 40 A/dm², on the other hand, burnt plating may occur. Therefore, such high and low current densities are not preferred.

An anti-pitting agent may also be added in an appropriate amount.

In the embodiment, the description has been made about the examples in which Cu plating and Ni plating (or Ni-alloy plating) were each conducted step by step by the roll-to-roll method. The present invention is, however, not limited to such modes.

### EXAMPLES

Examples will hereinafter be described to illustrate the present invention more specifically.

### Example 1

On a substrate, a matte Cu plating (a first metal layer 31) as a first metal layer, a matte Ni plating (a second metal layer 32) as a second metal layer, and a matte Cu plating (another first metal layer 31) as a third metal layer were formed sequentially.

Described more specifically, a known Ti material was first used as a substrate on an upper surface of which a laminated electrolytic foil was to be formed, and known pretreatments such as pickling and rinsing were applied to the Ti material.

The pretreated Ti material was next immersed in a matte Cu plating bath which will be described hereinafter, so that a first metal layer 31 (a matte Cu plating layer) of 2 μm thickness was formed as an electrolytic foil on the Ti substrate.

### [Matte Cu Plating Conditions]

Bath composition: a copper sulfate plating bath containing 200 g/L of copper sulfate as a principal component
   Copper sulfate: 200 g/L
   Sulfuric acid: 45 g/L
   Hydrochloric acid: 0.3 ml/L
Temperature: 50° C.
pH: 1 or lower
Agitation: air agitation
Current density: 20 A/dm²

The Ti material with the first metal layer 31 formed thereon was next immersed in an Ni plating bath which will be described hereinafter, so that a second metal layer 32 (a matte Ni plating layer) of 6 μm thickness was formed on the first metal layer 31.

### [Matte Ni Plating Conditions]

Bath composition: a Watts bath
   Nickel sulfate: 250 g/L
   Nickel chloride: 45 g/L
   Boric acid: 30 g/L
   Anti-pitting agent: 1 ml/L
Temperature: 30° C.
pH: 4.5
Agitation: air agitation
Current density: 10 A/dm²

The Ti material with the first metal layer 31 and the second metal layer 32 electroplated thereon was next immersed in a matte Cu plating bath. A matte Cu plating layer (a first metal layer 31) of 2 μm thickness was then formed as a third metal layer 31.

The plating layers formed as described above were next dried thoroughly, and thereafter the plating layers were peeled off from the Ti material to obtain a laminated metal foil (current collector).

### [Measurement of Tensile Force]

The laminated metal foil thus obtained was measured for mechanical strength (tensile strength) by a tension test that used a tension tester (“TENSILON RTC-1350A,” a universal material testing machine manufactured by ORIENTEC CORPORATION). The tensile strength was measured following the tensile testing method in JIS Z 2241. As illustrated in FIG. 3, a specimen was dimensioned to have a width of 15 mm and an extensometer gauge length of 50 mm. After reinforcing grip portions with an adhesive cellophane tape, a tensile test was conducted. The measurement was conducted under conditions of a room temperature and a pulling rate of 1 mm/min. The strength was evaluated to be “∘” (acceptable) when the resulting tensile strength had a value of 700 MPa or higher, or “x” (unacceptable) when the resulting tensile strength had a value of lower than 700 MPa. Results are presented in Table 1.

### [Crystal Orientation Index of Second Metal Layer]

The laminated metal foil thus obtained was determined for crystal orientation index in the second metal layer 32 (matte Ni plating) by X-ray diffraction analysis. For the X-ray diffraction, an automated X-ray diffractometer (“RINT 2500/PC”) manufactured by Rigaku Corporation was used. The measurement was conducted under the following conditions: X ray: Cu-40 kV-200 mA, scatter slit: ½ deg, divergence slit: ½ deg, receiving slit: 0.45 mm. The measurement range was set at 40°≤2θ≤100°. The individual peak intensities (cps) of the (111) plane, (200) plane, (220) plane, and (311) plane of a cross-section of the matte Ni plating layer were measured, and the crystal orientation indexes were determined in accordance with the above-mentioned formula.

### [Hardness of Second Metal Layer]

The laminated metal foil thus obtained was measured for hardness on the second metal layer 32 (matte Ni plating) as will be described hereinafter. Described specifically, using a Berkovich pyramidal indenter, the Martens hardness was measured under load conditions of 1 mN by a nanoindentation hardness testing machine (model number: ENT-1100a, manufactured by ELIONIX, INC.) in accordance with JIS Z 2255. It is to be noted that a sample was embedded in a resin and was sectioned, the resulting section surface was polished using a set of emery paper up to #1500 and was then buffed with diamond paste to a mirror finish, and the hardness of a portion of the second metal layer on the section of the laminated metal foil was measured.

### [Measurement of Electrical Conductivity]

The laminated electrolytic foil thus obtained was measured for electrical conductivity as will be described hereinafter. First, the laminated electrolytic foil was cut into a strip shape of 10 mm width and 100 mm length to provide a sample. Using a milliohm tester manufactured by HIOKI E.E. CORPORATION (model number: HIOKI 3540 AC mΩ HiTESTER), the resistance value of the sample in a length direction thereof was measured via clip-type leads at a distance (L) of 0.05 m between two points.

Measurement conditions were set as will be described hereinafter.

χ=L/(A×R)
χ: electrical conductivity (S/m)
L: distance (m) between two points for measuring

### Resistance Value

A: cross-sectional area of sample (m²)
R: resistance value (Ω) between the two points

Based on the numerical value of χ thus determined, the electrical conductivity was evaluated in accordance with the following determination standards.

χ≥1.0×10⁷: ∘

χ<1.0×10⁷: x

It is to be noted that as a reference value, the conductivity of a rolled copper foil of 50 μm in the present measurement method was χ=5.0×10⁷ S/m.

### Example 2

The procedures of Example 1 were followed except that the first metal layer (the matte Cu plating layer, the first metal layer 31) and the third metal layer (the matte Cu plating layer, the first metal layer 31) were changed to bright Cu plating layers.

### Example 3

The procedures of Example 1 were followed except that the individual plating layers were changed in thickness to those presented in Table 1.

### Example 4

The procedures of Example 1 were followed except that the individual plating layers were changed in thickness to those presented in Table 1.

### Example 5

On a Ti material, a matte Ni plating layer of 3 μm as a second metal layer 32, a matte Cu plating layer of 4 μm as a first metal layer 31, and a matte Ni plating layer of 3 μm as another second metal layer 32 were formed. Except for the foregoing, the procedures of Example 1 were followed.

### Example 6

The procedures of Example 1 were followed except that an Ni—Fe alloy plating layer was formed as the second metal layer 32. It is to be noted that conditions for Ni—Fe alloy plating will be described below.

### [Ni—Fe Alloy Plating Conditions]

Bath composition: a Watts bath
   Nickel sulfate: 200 g/L
   Ferrous chloride: 50 g/L
   Nickel chloride: 45 g/L
   Boric acid: 20 g/L
   Trisodium citrate: 5 g/L
   Saccharin: 5 g/L
   Anti-pitting agent: 1 ml/L
Temperature: 60° C.
pH: 2.8
Agitation: air agitation
Current density: 30 A/dm²

It is to be noted that the proportion of Fe in the Ni—Fe alloy plating was 50 wt %. By dissolving the Ni—Fe alloy layer of Example 6, measurements of an Ni amount and a Fe amount for the determination of the proportion of Fe were conducted by ICP emission spectroscopy (measurement instruments: ICPE-9000, an induction-coupled plasma emission spectrometer manufactured by SHIMADZU CORPORATION).

### Example 7

The procedures of Example 6 were followed except that the first metal layers 31 were changed to bright Cu plating. Bright Cu plating conditions were set similar to those in Example 2. It is to be noted that the proportion of Fe in the Ni—Fe alloy plating was 50 wt %. Results are presented in Table 1.

### Example 8

The procedures of Example 1 were followed except that the individual plating layers were changed in thickness to those presented in Table 1.

### Example 9

The procedures of Example 8 were followed except that the thickness of the second metal layer 32 (the matte Ni plating layer) was changed to 4 μm. Results are presented in Table 1.

### Example 10

The procedures of Example 1 were followed except that the second metal layer 32 was changed to a bright Ni plating layer. Conditions for bright Ni plating will be described below. Further, the results are presented in Table 1.

### [Bright Ni Plating Conditions]

Bath composition: a Watts bath
   Nickel sulfate: 300 g/L
   Nickel chloride: 10 g/L
   Boric acid: 20 g/L
   Brightener: 13 ml/L
Temperature: 40° C.
pH: 4.5
Agitation: air agitation
Current density: 15 A/dm²

### Example 11

The procedures of Example 2 were followed except that the second metal layer 32 was changed to a bright Ni plating layer. Conditions for bright Ni plating were set similar to those in Example 10. Further, the results are presented in Table 1.

### Example 12

The procedures of Example 4 were followed except that, in the plating conditions for the matte Ni plating layer as the second metal layer 32, the bath temperature and the current density were changed to 60° C. and 3 A/dm². Results are presented in Table 1.

### Example 13

The procedures of Example 4 were followed except that the matte Ni plating layer as the second metal layer 32 was formed in a sulfamate bath under conditions to be presented below. Results are presented in Table 1.

### [Matte Ni Plating (Sulfamate Bath) Conditions]

Bath composition: a sulfamate bath
   Nickel sulfamate: 300 g/L
   Nickel chloride: 10 g/L
   Boric acid: 20 g/L
   Anti-pitting agent: 1 ml/L
Temperature: 50° C.
pH: 4.5
Agitation: air agitation
Current density: 20 A/dm²

### Comparative Example 1

The procedures of Example 1 were followed except that the individual plating layers were changed in thickness to those presented in Table 1.

### Comparative Example 2

The procedures of Example 1 were followed except that in the plating conditions for the second metal layer 32 (the matte Ni plating layer), the current density was changed to 30 A/dm².

### Comparative Example 3

The procedures of Example 1 were followed except that in the plating conditions for the second metal layer 32 (the matte Ni plating layer), the current density was changed to 3 A/dm².

### Comparative Example 4

The procedures of Example 13 were followed except that the individual plating layers were changed in thickness to those presented in Table 1, and as conditions for the matte Ni plating (the sulfamate bath), the bath temperature and the current density were changed to 60° C. and 5 A/dm².

### Comparative Example 5

The procedures of Comparative Example 4 were followed except that the first metal layer and the third metal layer (the first metal layers 31) were changed to bright Cu plating layers. Bright Cu plating conditions were set similar to those in Example 2.

### Comparative Example 6

On a Ti material, a matte Cu plating layer of 10 μm thickness was formed as an electrolytic foil. Matte Cu plating conditions were set similar to those in Example 1. Results are presented in Table 1. It is to be noted that the hardness is the hardness of the matte Cu plating layer.

### Comparative Example 7

For the sake of a comparison, a rolled copper foil of 10 μm thickness was provided. As rolling conditions, known conditions were employed. Results are presented in Table 1. It is to be noted that the values of the hardness, crystal orientation index, and tensile strength are those measured on the rolled copper foil.

### Comparative Example 8

On a Ti material, a matte Ni plating layer of 10 μm thickness was formed as an electrolytic foil. Matte Ni plating conditions were set similar to those in Example 1 except that the bath temperature was changed to 60° C. Results are presented in Table 1.

### Comparative Example 9

On a Ti material, a matte Ni sulfamate plating layer of 10 μm thickness was formed as an electrolytic foil. Matte Ni sulfamate plating conditions were set as in Comparative Example 4 except that the current density was set at 10 A/dm². Results are presented in Table 1.

### Comparative Example 10

The procedures of Example 13 were followed except that the second metal layer 32 was changed to a bright Ni plating layer by sulfamate bath. Bright Ni plating (sulfamate bath) conditions were set similar to those in Example 13 except that a brightener was added at 10 ml/L. Results are presented in Table 1.

TABLE 1

| | | Layer configuration | | | Thickness (μm) | | | Plating conditions | | | |
|---|---|---|---|---|---|---|---|---|---|---|---|
| | | 1st | 2nd | 3rd | 1st | 2nd | 3rd | Kind of | Bath | | |
| | | layer | layer | layer | layer | layer | layer | plating | temp. | pH | CD |
| Ex. 1 | Laminated foil | Matte Cu | Matte Ni | Matte Cu | 2 | 6 | 2 | Matte Ni | 30 | 4.5 | 10 |
| Ex. 2 | Laminated foil | Bright Cu | Matte Ni | Bright Cu | 2 | 6 | 2 | Matte Ni | 30 | 4.5 | 10 |
| Ex. 3 | Laminated foil | Matte Cu | Matte Ni | Matte Cu | 2.5 | 5 | 2.5 | Matte Ni | 30 | 4.5 | 10 |
| Ex. 4 | Laminated foil | Matte Cu | Matte Ni | Matte Cu | 1 | 8 | 1 | Matte Ni | 30 | 4.5 | 10 |
| Ex. 5 | Laminated foil | Matte Ni | Matte Cu | Matte Ni | 3 | 4 | 3 | Matte Ni | 30 | 4.5 | 10 |
| Ex. 6 | Laminated foil | Matte Cu | Ni—Fe | Matte Cu | 2 | 6 | 2 | Ni—Fe | 80 | 2.8 | 30 |
| Ex. 7 | Laminated foil | Bright Cu | Ni—Fe | Bright Cu | 2 | 6 | 2 | Ni—Fe | 80 | 2.8 | 30 |
| Ex. 8 | Laminated foil | Matte Cu | Matte Ni | Matte Cu | 1 | 2 | 1 | Matte Ni | 30 | 4.5 | 10 |
| Ex. 9 | Laminated foil | Matte Cu | Matte Ni | Matte Cu | 1 | 4 | 1 | Matte Ni | 30 | 4.5 | 10 |
| Ex. 10 | Laminated foil | Matte Cu | Bright Ni | Matte Cu | 2 | 6 | 2 | Bright Ni | 40 | 4.5 | 15 |
| Ex. 11 | Laminated foil | Bright Cu | Bright Ni | Bright Cu | 2 | 6 | 2 | Bright Ni | 40 | 4.5 | 15 |
| Ex. 12 | Laminated foil | Matte Cu | Matte Ni | Matte Cu | 1 | 8 | 1 | Matte Ni | 80 | 4.5 | 3 |
| Ex. 13 | Laminated foil | Matte Cu | Ni sulfamate | Matte Cu | 1 | 8 | 1 | Ni sulfamate (matte) | 50 | 4.5 | 20 |
| Comp. Ex. 1 | Laminated foil | Matte Cu | Matte Ni | Matte Cu | 3 | 4 | 3 | Matte Ni | 30 | 4.5 | 10 |
| Comp. Ex. 2 | Laminated foil | Matte Cu | Matte Ni | Matte Cu | 2 | 6 | 2 | Matte Ni | 30 | 4.5 | 30 |
| Comp. Ex. 3 | Laminated foil | Matte Cu | Matte Ni | Matte Cu | 2 | 6 | 2 | Matte Ni | 80 | 4.5 | 3 |
| Comp. Ex. 4 | Laminated foil | Matte Cu | Ni sulfamate | Matte Cu | 2 | 6 | 2 | Ni sulfamate (matte) | 80 | 4.5 | 5 |
| Comp. Ex. 5 | Laminated foil | Bright Cu | Ni sulfamate | Bright Cu | 2 | 6 | 2 | Ni sulfamate (matte) | 80 | 4.5 | 5 |
| Comp. Ex. 6 | Single-layer foil | Electrolytic Cu | | | 10 | | | — | — | — | — |
| Comp. Ex. 7 | Single-layer foil | Rolled Cu | | | 10 | | | — | — | — | — |
| Comp. Ex. 8 | Single-layer foil | Matte Ni | | | 10 | | | Matte Ni | 60 | 4.5 | 10 |
| Comp. Ex. 9 | Single-layer foil | Ni sulfamate | | | 10 | | | Ni sulfamate (matte) | 60 | 4.5 | 10 |
| Comp. Ex. 10 | Laminated foil | Matte Cu | Ni sulfamate | Matte Cu | 1 | 8 | 1 | Ni sulfamate (bright) | 50 | 4.5 | 20 |
| | | | (bright) | | | | | | | | |

| | Thickness ratio | Hardness of | Crystal orientation | | | | | | | Electrical |
|---|---|---|---|---|---|---|---|---|---|---|
| | (2nd metal | 2nd metal layer | index of Ni | | | | | TS | | conduc- |
| | layer/all layers) | [N/mm2] | (111) | (200) | (220) | (311) | (200)/(220) | [MPa] | Strength | tivity |
| Ex. 1 | 0.60 | 3900 | 1.0 | 1.3 | 0.8 | 0.7 | 1.6 | 880 | ∘ | ∘ |
| Ex. 2 | 0.60 | 3900 | 1.1 | 1.2 | 0.7 | 0.6 | 1.7 | 1,070 | ∘ | ∘ |
| Ex. 3 | 0.50 | 3600 | 0.7 | 1.2 | 2.3 | 0.7 | 0.5 | 790 | ∘ | ∘ |
| Ex. 4 | 0.80 | 3800 | 0.6 | 2.3 | 1.0 | 0.5 | 2.4 | 1140 | ∘ | ∘ |
| Ex. 5 | 0.60 | 3700 | 0.9 | 1.2 | 1.5 | 0.7 | 0.8 | 910 | ∘ | ∘ |
| Ex. 6 | 0.60 | 4500 | 1.2 | 1.4 | 0.0 | 0.4 | | 1,200 | ∘ | ∘ |
| Ex. 7 | 0.60 | 4500 | 1.2 | 1.4 | 0.0 | 0.4 | | 1,200 | ∘ | ∘ |
| Ex. 8 | 0.50 | 3500 | 0.8 | 1.3 | 2.1 | 0.6 | 0.8 | 740 | ∘ | ∘ |
| Ex. 9 | 0.67 | 3600 | 0.8 | 1.1 | 3.2 | 0.5 | 0.3 | 890 | ∘ | ∘ |
| Ex. 10 | 0.60 | 5200 | 1.3 | 0.8 | 0.2 | 0.7 | 3.2 | 970 | ∘ | ∘ |
| Ex. 11 | 0.60 | 5300 | 1.4 | 0.7 | 0.3 | 0.7 | 2.5 | 1,120 | ∘ | ∘ |
| Ex. 12 | 0.80 | 3300 | 0.4 | 1.1 | 4.2 | 0.5 | 0.3 | 820 | ∘ | ∘ |
| Ex. 13 | 0.80 | 3000 | 0.3 | 3.5 | 0.1 | 0.1 | 38.5 | 890 | ∘ | ∘ |
| Comp. Ex. 1 | 0.40 | 3400 | 0.6 | 1.1 | 2.9 | 0.8 | 0.4 | 680 | x | ∘ |
| Comp. Ex. 2 | 0.60 | | | | | | | Impossible to | — | — |
| | | | | | | | | prepare | | |
| | | | | | | | | specimen | | |
| Comp. Ex. 3 | 0.60 | 2800 | 0.4 | 1.2 | 3.8 | 0.4 | 0.3 | 690 | x | ∘ |
| Comp. Ex. 4 | 0.60 | 3600 | 0.4 | 3.1 | 0.2 | 0.5 | 12.8 | 685 | x | ∘ |
| Comp. Ex. 5 | 0.60 | 3500 | 0.8 | 2.2 | 0.3 | 0.4 | 6.2 | 629 | x | ∘ |
| Comp. Ex. 6 | — | 1900 | | | | | | 350 | x | ∘ |
| Comp. Ex. 7 | — | 2000 | | | | | | 400 | x | ∘ |
| Comp. Ex. 8 | — | 2800 | 0.8 | 2.8 | 0.0 | 0.2 | 85.0 | 890 | x | x |
| Comp. Ex. 9 | — | 2800 | 0.1 | 4.0 | 0.0 | 0.1 | 197.5 | 700 | x | x |
| Comp. Ex. 10 | 0.80 | | | | | | | Impossible to | — | — |
| | | | | | | | | prepare | | |
| | | | | | | | | specimen | | |

Each example was confirmed to have preferred properties such as tensile strength and hardness. In the comparative examples, on the other hand, none of the foils were confirmed to have such preferred properties.

In the present invention, it is notable that the laminated electrolytic foils were successfully obtained with excellent tensile strength and superb electrical conductivity in comparison with the conventional electrolytic copper foil and rolled copper foil despite the laminated electrolytic foils were thin.

It is to be noted that tensile strength has a value which theoretically remains unaffected by thickness. Practically, however, it has been found by the present inventors that the tensile strength decreases beyond a theoretical value if the thickness of a layer is reduced. This is considered to be attributable, for example, to the fact that the tensile strength is more susceptible to effects of pinholes.

In the present invention, on the other hand, the adoption of the above-described configurations has made it possible to control the crystal orientation and hardness of each layer at preferred values and, as a consequence, has made it possible to achieve excellent tensile strength despite the small thickness.

It is to be noted that various modifications can be made to the above-described embodiment and individual examples within a scope not departing from the spirit of the present invention.

Further, the laminated electrolytic foils of the above-described embodiment and examples have been described as those which are primarily for use as current collectors for batteries. However, the present invention can be applied as laminated metal foils not only to current collectors but also to other applications such as heat dissipation materials and electromagnetic wave shielding materials.

In addition, the sandwiching of a Cu layer between Ni layers can suppress the corrosion of the Cu layer, and therefore can also be applied, for example, to sulfide-based solid-state batteries.

### INDUSTRIAL APPLICABILITY

As has been described above, laminated metal foils, battery current collectors, and batteries of the present invention can be applied to a wide field of industries such as automotive vehicles and electronic equipment.

### REFERENCE SIGNS LIST

31 First metal layer
32 Second metal layer
A Laminated electrolytic foil

1. A laminated electrolytic foil comprising:
a first metal layer formed from Cu and a second metal layer formed from Ni or an Ni alloy, the first metal layer and the second metal layer being laminated together, wherein
the laminated electrolytic foil has an overall layer thickness of 3 to 15 μm and tensile strength of 700 MPa or higher.

2. The laminated electrolytic foil according to claim 1, wherein
the laminated electrolytic foil has a three-layer structure that the second metal layer, the first metal layer, and the second metal layer are laminated in this order.

3. The laminated electrolytic foil according to claim 1, wherein the laminated electrolytic foil has a three-layer structure that the first metal layer, the second metal layer, and the first metal layer are laminated in this order.

4. The laminated electrolytic foil according to claim 1, wherein the second metal layer has a thickness ratio of 0.45 or greater but 0.9 or smaller relative to the overall layer thickness as a sum of the first metal layer and the second metal layer.

5. The laminated electrolytic foil according to claim 1, wherein the second metal layer has hardness of 3500 to 5500 N/mm².

6. The laminated electrolytic foil according to claim 1, wherein Ni in the second metal layer laminated on the first metal layer has a crystal orientation index of 0.3 or greater in a plane, and the crystal orientation index of the plane/a crystal orientation index of a plane has a value of 0.1 to 5.0.

7. The laminated electrolytic foil according to claim 1, wherein the Ni alloy contains Fe.

8. The laminated electrolytic foil according to claim 1, wherein the overall layer thickness is 4 to 10 μm.

9. A battery comprising the laminated electrolytic foil according to claim 1.
